(19) United States
(12) Patent Application Publication
(10) Pub. No.: US 2010/0244560 A1
(43) Pub. Date: Sep. 30, 2010

(54) VEHICLE POWER SUPPLY SYSTEM

(75) Inventors: Yoshihiro Sato, Kasugai-shi (JP); Kenichi Kessoku, Kasugai-shi (JP); Hirohito Miyazaki, Gifu-shi (JP)

Correspondence Address: OSHA LIANG L.L.P., TWO HOUSTON CENTER, 909 FANNIN, SUITE 3500, HOUSTON, TX, 77010, US

(73) Assignee: OMRON CORPORATION, Kyoto-shi (JP)

(21) Appl. No.: 12/713,994

(22) Filed: Feb. 26, 2010

(30) Foreign Application Priority Data
Mar. 3, 2009 (JP) 2009-049099

(51) Int. Cl. B60L 1/00

(52) U.S. Cl. 307/10.1

(57) ABSTRACT

A vehicle power supply system has a power supply unit for supplying power to each unit of a vehicle, a plurality of actuation units actuated by the power from the power supply unit, an operation unit arranged for each of the plurality of actuation units, and operated when actuating the corresponding actuation unit, and a control unit for performing a control of starting supply of power from the power supply unit to each of the plurality of actuation units according to the operation of the corresponding operation unit when an actuation condition of the actuation unit corresponding to the operation unit is satisfied.

### BACKGROUND OF THE INVENTION

1. Technical Field

The present invention relates to vehicle power supply systems, and in particular, to a vehicle power supply system capable of suppressing the consumption of power and enhancing the convenience.

2. Related Art

Conventionally, in a vehicle power supply system, the supply of power from a battery to each load starts all at once when a control device detects that the driver operated a ignition switch using a key of a vehicle or when the driver operated a push switch.

The conventional vehicle power supply system will be described with reference to FIG. 1.

A vehicle power supply system 11 shown in FIG. 1 is configured to include a battery 12, an ignition switch 13, a +B drive load 14, an accessory system load 15, an ignition system load 16, a start system load 17, a control device 18, an operation switch 19, a legitimate user detection unit 20, a safety detection unit 21, and a battery voltage detection unit 22.

In the vehicle power supply system 11, the battery 12 is directly connected to the +B drive load 14, and also connected to the accessory system load 15, the ignition system load 16, and the start system load 17 through the ignition switch 13.

For instance, when the driver operates the ignition switch 13 using the key of the vehicle, the supply of power from the battery 12 to the accessory system load 15, the ignition system load 16, and the start system load 17 starts all at once through the ignition switch 13.

For instance, if the legitimate user detection unit 20 detects that the driver is a legitimate user, the safety detection unit 21 detects the safety of the vehicle, and the battery voltage detection unit 22 detects that the voltage of the battery 12 is normal when the driver operates the operation switch 19 including a push switch, the control device 18 supplies power all at once from the battery 12 to the accessory system load 15, the ignition system load 16, and the start system load 17 through the ignition switch 13.

Each load is actuated when the driver operates the operation switch for actuating each load (e.g., startup switch of radio receiver, actuation switch of power window, etc.), as necessary, after the accessory system load 15, the ignition system load 16, and the start system load 17 are in the power supply state.

Japanese Unexamined Patent Publication No. 2003-42044 discloses an expanded ignition system in which the operation switch for switching the supply of power to the start system load, the ignition system load, and the accessory load is expanded.

### SUMMARY

In the conventional vehicle power supply system, the power is unnecessarily consumed since the supply of power to the accessory system load, the ignition system load, and the start system load is performed all at once. Specifically, when the ignition switch is operated, the power is supplied to the accessory system load along with the ignition system load and the start system load, and thus the radio receiver is in the power supply state and consumes power even if the driver is not using the radio receiver (radio receiver is not operating).

To operate the functions related to the accessory system load and the ignition system load, the ignition switch needs to be operated before operating the operation switch of such functions, and hence the convenience is low. Specifically, the ignition switch needs to be operated to have the audio, the navigation system, and the like in the power supply state before operating the startup switch for starting up the audio, the navigation system, and the like.

One or more embodiments of the present invention suppresses the consumption of power and to enhances the convenience in a vehicle power supply system.

### BRIEF DESCRIPTION OF THE DRAWINGS

FIG. 1 is a block diagram showing a configuration example of a conventional vehicle power supply system;

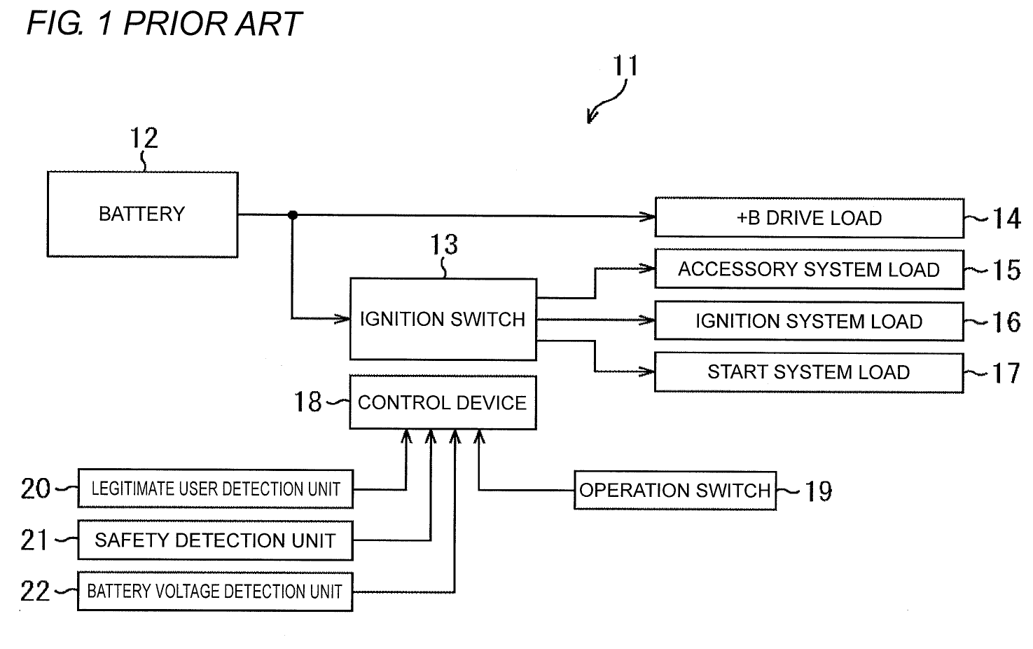

FIG. 2 is a block diagram showing a configuration example of one embodiment of a vehicle power supply system applying one or more embodiments of the present invention;

FIG. 3 is a block diagram showing a configuration example of an ignition system load 36;

FIG. 4 is a flowchart describing a process in which a power supply control device 41 starts up an accessory load system 34;

FIG. 5 is a flowchart describing the process in which the power supply control device 41 starts up the ignition system load 36; and

FIG. 6 is a flowchart describing the process in which the power supply control device 41 starts up the start system load 38.

### DETAILED DESCRIPTION

Hereinafter, specific embodiments applying the present invention will be described in detail with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

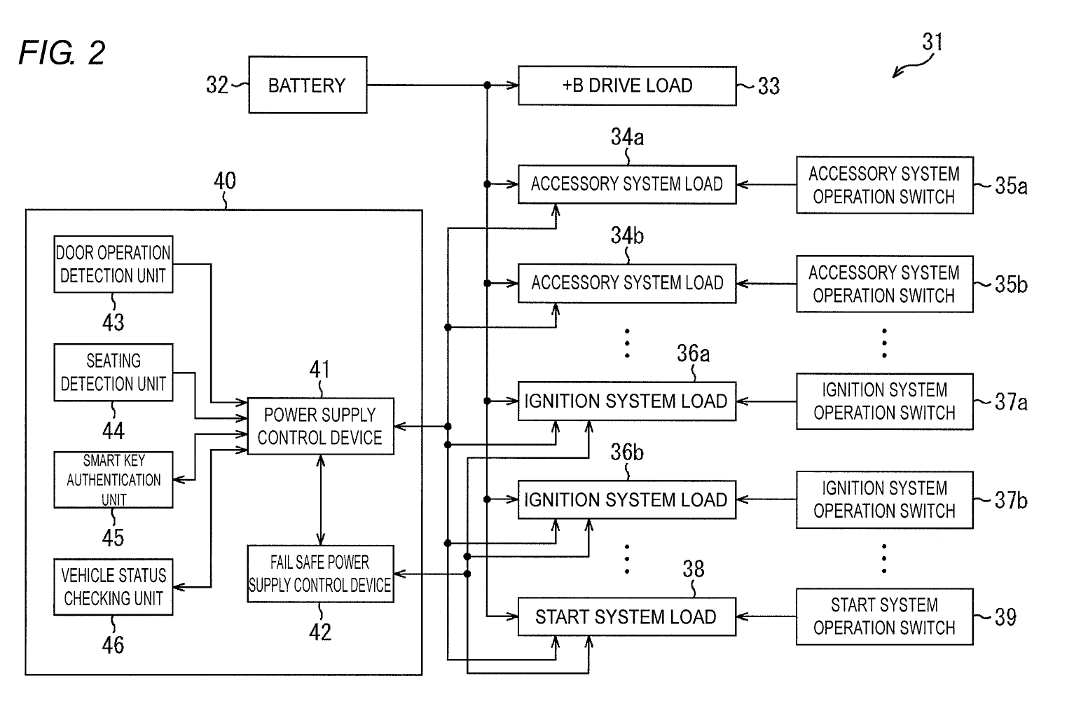

FIG. 2 is a block diagram showing a configuration example of one embodiment of a vehicle power supply system applying one or more embodiments of the present invention. In the present specification, the system represents the entire apparatus configured by a plurality of devices.

In FIG. 2, a vehicle power supply system 31 is configured to include a battery 32, a +B drive load 33, accessory system loads 34a and 34b, accessory system operation switches 35a and 35b, ignition system loads 36a and 36b, ignition system operation switches 37a and 37b, a start system load 38, a start system operation switch 39, and a control unit 40.

The battery 32 is directly connected to the +B drive load 33, the accessory system loads 34a and 34b, the ignition system loads 36a and 36b, and the start system load 38, and supplies power necessary to drive each load.

The +B drive load 33 is a headlight, a phone, and the like, and is constantly supplied with power from the battery 32.

The accessory system loads 34a and 34b are a radio receiver, a car air conditioner, a car navigation, and the like, and starts up according to the control of the control unit 40 corresponding to the operation of the accessory system operation switches 35a and 35b. The accessory system operation switches 35a and 35b are operated when the user starts or stops the accessory system loads 34a and 34b.

In the vehicle power supply system 31, the battery 32 is connected to a plurality of accessory system loads 32 other than the two accessory system loads 34a and 34b, but the illustration of the accessory system load other than the accessory system loads 34a and 34b is omitted in the example of FIG. 2. Similarly, the illustration of the accessory system operation switch other than the accessory system operation switches 35a and 35b is omitted. Furthermore, if the accessory system loads 34a and 34b do not need to be distinguished, they are hereinafter appropriately referred to as an accessory system load 34. Similarly, the accessory system operation switches 35a and 35b are referred to as an accessory system operation switch 35.

The ignition system loads 36a and 36b are a power window, a window washer, and the like, and are actuated according to the control of the control unit 40 corresponding to the operation of the ignition system operation switches 37a and 37b. The ignition system operation switches 37a and 37b are operated when the user actuates the ignition system loads 36a and 36b.

Similar to the accessory system loads 34a and 34b, the ignition system loads 36a and 36b and the ignition system operation switches 37a and 37b are respectively referred to as an ignition system load 36 and an ignition system operation switch 37.

The start system load 38 is an engine ignition plug, a fuel pump, a radiator fan, and the like, and starts according to the control of the control unit 40 corresponding to the operation of the start system load 38. If the vehicle is an electric vehicle, a hybrid vehicle, and the like, the start system load 38 is an axle drive motor etc. The start system operation switch 39 is operated when the user starts or stops the engine of the vehicle.

The control unit 40 is configured to include a power supply control device 41, a fail safe power supply control device 42, a door operation detection unit 43, a seating detection unit 44, a smart key authentication unit 45, and a vehicle status checking unit 46, and controls the startup or the actuation of the accessory system load 34, the ignition system load 36, and the start system load 38.

The power supply control device 41 communicates with the door operation detection unit 43, the seating detection unit 44, the smart key authentication unit 45, and the vehicle status chucking unit 46 according to a predetermined communication standard such as a B-CAN (B-Controller Area Network) to grasp the state of the vehicle. When each condition for starting up or actuating each of the accessory system load 34, the ignition system load 36, or the start system load 38 is satisfied, the power supply control device 41 transmits a control signal for permitting startup or actuation to the accessory system load 34, the ignition system load 36, or the start system load 38 to start up or actuate the same.

The fail safe power supply control device 42 is connected with the power supply control device 41 to be communicable with each other, and performs the control (backup) for starting up the load on behalf of the power supply control device 41 when the ignition system load 36 or the start system load 38 did not actuate although the power supply control device 41 performed a control of starting up the ignition system load 36 or the start system load 38 due to occurrence of some kind of improper operation such as the shielding of control signal. The fail safe power supply control device 42 lights on a warning lamp of an indicator in a meter panel of the vehicle to notify the driver that abnormality occurred.

For instance, when detecting abnormality of the start system load 38 (e.g., monitoring the ignition timing of the engine ignition plug, and detecting the occurrence of abnormality when not matching the control by the power supply control device 41) based on a communication signal from the power supply control device 41, the fail safe power supply control device 42 performs the control of the start system load 38 so that the vehicle safely stops. The fail safe power supply control device 42 can appropriately select a means for notifying abnormality to the driver according to the level of importance of the load system in which the abnormality occurred.

The door operation detection unit 43 includes a door sensor for detecting opening/closing of the door of the vehicle, and when detecting that the door of the vehicle changed from close to open, transmits a communication signal (door opening event trigger) indicating the same to the power supply control device 41.

The seating detection unit 44 includes a seating sensor for detecting that the user is seated on the seat of the vehicle, and when detecting that the user is seated on the seat, transmits a communication signal indicating the same to the power supply control device 41.

The smart key authentication unit 45 performs an authentication process with the smart key owned by the user, and transmits the authentication result that the user is a legitimate user to the power supply control device 41 when confirming that the user who opened the door is a legitimate user or the user seated on the seat is a legitimate user. In other words, the smart key authentication unit 45 stores a vehicle ID for specifying a vehicle and transmits a command requesting for the vehicle ID to the smart key, and the smart key transmits a response including the vehicle ID it stores. The smart key authentication unit 45 receives the response, and checks the vehicle ID contained in the response and the vehicle ID it stores to confirm that the user is a legitimate user.

The smart key authentication unit 45 measures the signal intensity of the signal transmitted from the smart key, and provides the measurement result to the power supply control device 41 when communicating with the smart key. The signal intensity of the signal transmitted from the smart key is used to determine whether or not the smart key is in the vehicle.

The vehicle status checking unit 46 includes a sensor for checking the status of each unit of the vehicle, and notifies the status of each unit to the power supply control device 41. For instance, the vehicle status checking unit 46 notifies the power supply control device 41 whether the state of the brake switch of the vehicle is ON or OFF, in which range (P (parking), N (neutral), etc.) the shift position of the vehicle is at, and the like.

The seating detection unit 44, the smart key authentication unit 45, and the vehicle status checking unit 46 are normally in a power saving state (sleep mode), where the power supply control device 41 performs a control to transition the seating detection unit 44, the smart key authentication unit 45, and the vehicle status checking unit 46 from a power saving state to the standby state (standby mode) when receiving a door opening event trigger transmitted from the door operation detection unit 43.

In the vehicle power supply system 31 configured as above, when the user operates the ignition system operation switch 37 to actuate the ignition system load 36, and the operation signal thereof is provided to the ignition system load 36, the ECU (Electronic Control Unit) of the ignition system load 36 transmits a control signal requesting for permission of actuation to the control unit 40. When the control signal for permitting the actuation is provided from the control unit 40 to the ignition system load 36 in response to such control signal, the ignition system load 36 is actuated by the power supply from the battery 32.

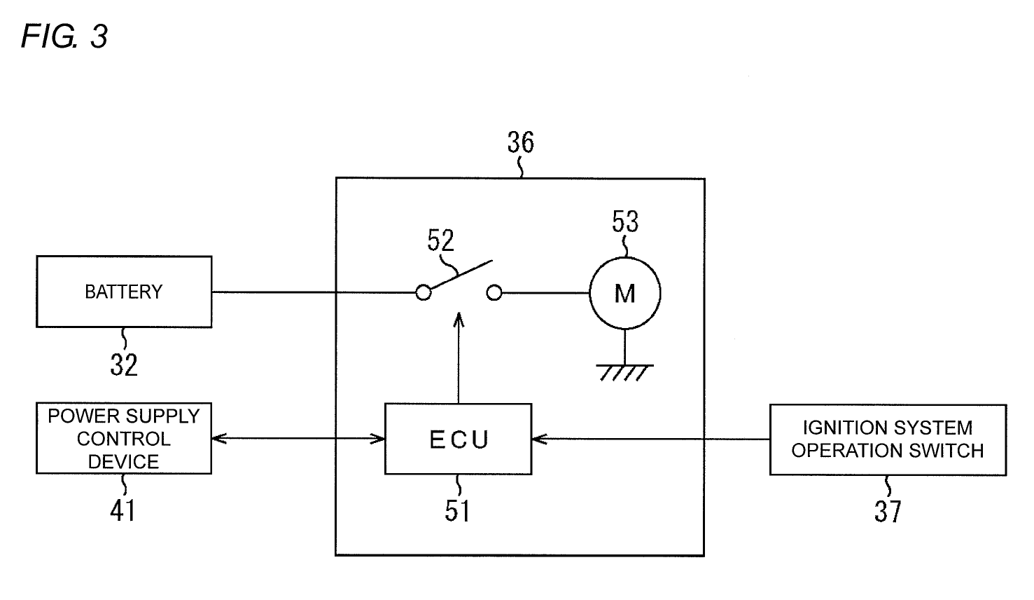

The process of when the ignition system load 36 is actuated will be described with reference to FIG. 3. FIG. 3 is a block diagram showing a configuration example of the ignition system load 36.

The ignition system load 36 is configured to include an ECU 51, a switch 52, and a drive unit 53.

The ECU 51 opens and closes the switch 52 according to the control of the power supply control device 41 to control the power to supply from the battery 32 to the drive unit 53. The drive unit 53 is, for example, a motor for opening and closing the window of a vehicle.

When the user operates the ignition system operation switch 37 to actuate the ignition system load 36, the operation signal corresponding to such operation is provided to the ECU 51, and the ECU 51 starts up from the power saving state and communicates with the power supply control device 41. The power supply control device 41 checks the state of the vehicle, and transmits the control signal for permitting the actuation to the ECU 51 when the condition for actuating the ignition system load 36 is satisfied. The ECU 51 thus closes the switch 52 according to the control signal (changes to a state the switch 52 is turned ON), so that the power is supplied from the battery 32 to the drive unit 53, and the ignition system load 36 is actuated.

Similar to the ignition system load 36, the accessory system load 34 and the start system load 38 respectively includes the ECU, and start up after each ECU communicates with the control unit 40 according to the operation signal from the accessory system operation switch 35 and the start system operation switch 39.

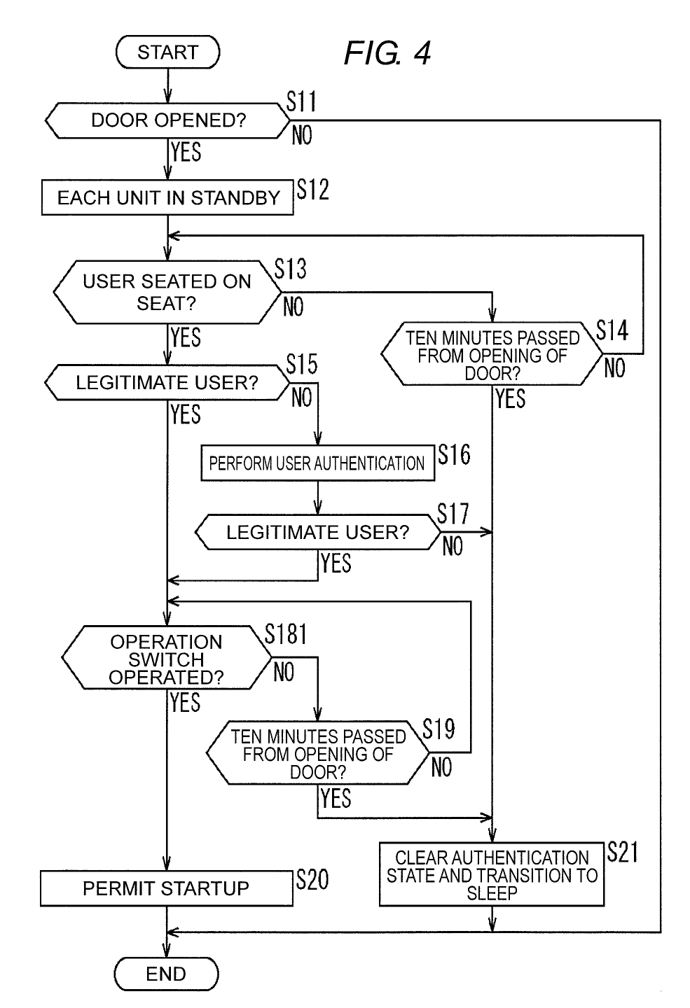

FIG. 4 is a flowchart describing the process in which the power supply control device 41 of FIG. 2 starts up the accessory system load 34 (e.g., radio receiver).

In step S11, the power supply control device 41 determines whether or not the door of the vehicle changed from close to open.

In other words, the power supply control device 41 waits for the communication signal (door opening event trigger) indicating that the door of the vehicle changed from close to open to be transmitted from the door operation detection unit 43, and receives the door opening event trigger when the door operation detection unit 43 transmits the door opening event trigger and determines that the door of the vehicle changed from close to open.

In step S11, the process proceeds to step S12 if the power supply control device 41 determines that the door of the vehicle changed from close to open, and the power supply control device 41 communicates with the seating detection unit 44, the smart key authentication unit 45, and the vehicle status checking unit 46 to transition each unit from the power saving state to the standby state (standby).

After the process of step S12, the process proceeds to step S13, and the power supply control device 41 determines whether or not the user is seated based on the communication signal from the seating detection unit 44. For instance, when the seating detection unit 44 transmits a communication signal indicating that the user is seated on the seat and the power supply control device 41 receives the communication signal, the power supply control device 41 determines that the user is seated on the seat.

The process proceeds to step S14 if the power supply control device 41 determines that the user is not seated on the seat in step S13, and the process proceeds to step S15 if determined that the user is seated on the seat.

In step S14, the power supply control device 41 determines whether or not an elapsed time from the time determined that the door of the vehicle changed from close to open in step S11 exceeded ten minutes.

The process returns to step S13 if the power supply control device 41 determines that the elapsed time has not exceeded ten minutes in step S14. In other words, if the user is seated on the seat within ten minutes from the time the door of the vehicle changed from close to open from the processes of steps S13 and S14, the process proceeds to step S15.

In step S15, the power supply control device 41 determines whether or not an authentication result that the user seated on the seat is a legitimate user is obtained.

For instance, when the user is unlocking the vehicle using the smart key, the authentication process is performed between the smart key owned by the user and the smart key authentication unit 45, where the power supply control device 41 already received the authentication result that the user is a legitimate user from the smart key authentication unit 45 if the user who unlocked the vehicle is a legitimate user. Therefore, the power supply control device 41 determines that the authentication result that the user seated on the seat is a legitimate user is obtained if already receiving the authentication result that the user is a legitimate user. If the user is not unlocking the vehicle using the smart key, the power supply control device 41 determines that the authentication result that the user seated on the seat is a legitimate user is not obtained.

The process proceeds to step S16 if the power supply control device 41 determines that the authentication result that the user seated on the seat is a legitimate user is not obtained in step S15, and the power supply control device 41 performs the authentication process by controlling the smart key authentication unit 45. The smart key authentication unit 45 executes the authentication process with the smart key owned by the user, and provides the authentication result that the user seated on the seat is a legitimate user to the power supply control device 41 if the vehicle IDs match through checking, as described above.

After the process of step S16, the process proceeds to step S17, and the power supply control device 41 determines whether or not a legitimate user is seated on the seat. For instance, the power supply control device 41 determines that the legitimate user is seated on the seat if the authentication result that the user seated on the seat is a legitimate user is provided from the smart key authentication unit 45 in step S16.

If determined that the authentication result that the user seated on the seat is a legitimate user is obtained in step S15, or if determined that the legitimate user is seated on the seat in step S17, the process proceeds to step S18.

In step S18, the power supply control device 41 determines whether or not the user performed the operation of starting up the accessory system load 34 (e.g., operation of turning ON the radio receiver) based on the communication signal from the accessory system load 34. For instance, when the ECU of the accessory system load 34 transmits a communication signal asking for permission to startup according to the operation of the accessory system operation switch 35 by the user, the power supply control device 41 determines that the user performed the operation of starting up the accessory system load 34 when receiving the communication signal.

The process proceeds to step S19 if the power supply control device 41 determines that the user performed the operation of starting up the accessory system load 34 in step S18, and the process proceeds to step S20 if determined that the user performed the operation of starting up the accessory system load 34.

In step S19, the power supply control device 41 determines whether or not an elapse time from the time determined that the door of the vehicle changed from close to open in step S11 exceeded ten minutes.

The process returns to step S18 if the power supply control device 41 determines that the elapsed time did not exceed ten minutes in step S19. In other words, the process proceeds to step S20 if the user performed the operation of starting up the accessory system load 34 within ten minutes from the time the door of the vehicle changed from close to open through the processes of steps S18 and S19.

In step S20, the power supply control device 41 transmits a control signal permitting the startup to the accessory system load 34. In other words, in this case, the power supply control device 41 permits the startup of the accessory system load 34 since the condition that the legitimate user is seated, which is a condition for starting up the accessory system load 34, is satisfied. The ECU of the accessory system load 34 starts the supply of power from the battery 32 to each unit of the accessory system load 34 according to the control signal for permitting startup. The accessory system load 34 is thereby started up (e.g., radio receiver is turned ON), and the process is terminated.

The process proceeds to step S21 if determined by the power supply control device 41 that the elapsed time exceeded ten minutes in step S14, if determined that the legitimate user is not seated on the seat in step S17, or if determined that the elapsed time exceeded ten minutes in step S19.

In step S21, the power supply control device 41 clears the authentication state of the user (returns to initial state) and transitions each portion of the control unit 40 to the power saving mode (sleep), so that the process is terminated. The process is terminated if the power supply control device 41 determines that the door of the vehicle is not changed from close to open in step S11.

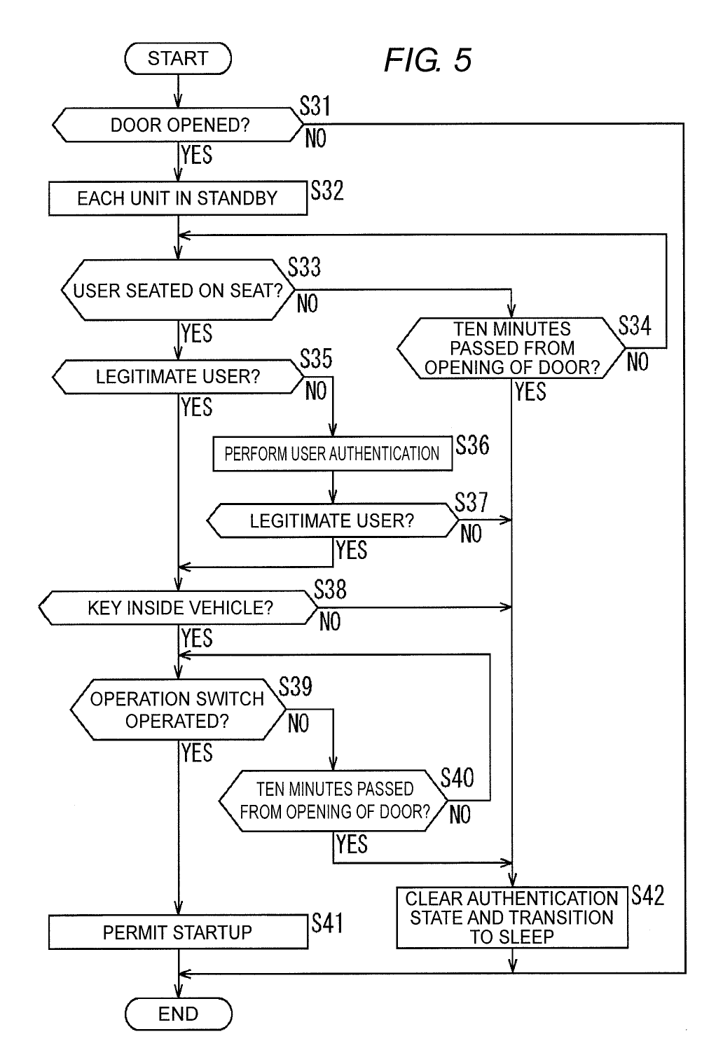

FIG. 5 is a flowchart describing the process in which the power supply control device 41 of FIG. 2 actuates the ignition system load 36 (e.g., power window).

The processes of steps S31 to S37 are processes similar to the processes of steps S11 to S17 of FIG. 4, and thus the description on such processes will be omitted.

In step S38, the power supply control device 41 determines whether or not the smart key is in the interior of the vehicle through the smart key authentication unit 45.

The smart key authentication unit 45 communicates with the smart key, measures the signal intensity of the signal transmitted from the smart key, and provides the measurement result to the power supply control device 41. Although whether or not the smart key is in the interior of the vehicle is determined in the authentication process of the user using the smart key as well, whether the smart key is in the interior of the vehicle is again checked since the degree of importance is high in the power ON of the ignition system load 36 compared to the accessory system load 34, for example, consideration is to be made for a case in a which the vehicle interior submerges under water in time of rain in the power window application.

The power supply control device 41 determines that the smart key is in the interior of the vehicle if the signal intensity is greater than or equal to a predetermined threshold value, and determines that the smart key is not in the interior of the vehicle (in the exterior) if the signal intensity is smaller than the predetermined threshold value based on the measurement result from the smart key authentication unit 45.

The process proceeds to step S39 if the power supply control device 41 determines that the smart key is in the interior of the vehicle instep S38.

Similar to steps S18 and S19 of FIG. 4, in steps S39 and S40, the power supply control device 41 determines whether or not the user performed the operation of actuating the ignition system load 36 within ten minutes from the time the door of the vehicle changed from close to open in step S31, and the process proceeds to step S41 if determined that the user performed the operation of starting up the ignition system load 36 within ten minutes from opening the door.

In step S41, the power supply control device 41 transmits a control signal for permitting actuation to the ignition system load 36. In other words, in this case, the power supply control device 41 permits the actuation of the ignition system load 36 since the conditions that the legitimate user is seated and that the smart key is in the interior of the vehicle, which are conditions for actuating up the ignition system load 36, are satisfied. The ECU 51 (FIG. 3) of the ignition system load 36 closes the switch 52, and starts the supply of power from the battery 32 to the drive unit 53 according to the control signal for permitting the actuation. The ignition system load 36 is thereby actuated, for example, the drive unit 53 slides the window, and the process is terminated.

The process proceeds to step S42 if determined by the power supply control device 41 that the elapsed time exceeded ten minutes in step S44, if determined that the legitimate user is not seated on the seat in step S37, if determined that the smart key is not in the interior of the vehicle in step S38, or if determined that the elapsed time exceeded ten minutes in step S40.

In step S42, the power supply control device 41 clears the authentication state of the user and transitions each portion of the control unit 40 to the power saving mode, so that the process is terminated. The process is terminated if the power supply control device 41 determines that the door of the vehicle is not changed from close to open in step S31.

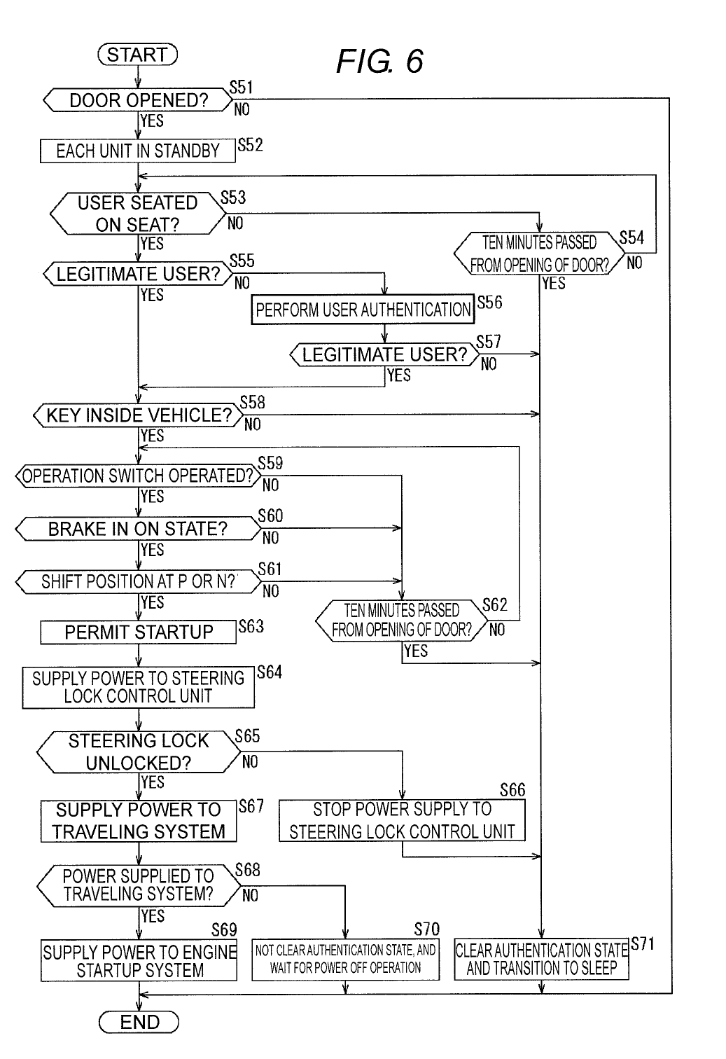

FIG. 6 is a flowchart describing the process in which the power supply control device 41 of FIG. 2 starts up the start system load 38 (e.g., starts up engine).

The processes of steps S51 to S57 are processes similar to the processes of steps S11 to S17 of FIG. 4, and thus the description on such processes will be omitted.

In step S58, the power supply control device 41 determines whether or not the smart key is in the interior of the vehicle through the smart key authentication unit 45, similar to step S38 of FIG. 5, and the process proceeds to step S59 if determined that the smart key is in the interior of the vehicle.

In step S59, the power supply control device 41 determines whether or not the user performed the operation of starting up the start system load 38 (e.g., operation of turning ON the push switch for engine startup) based on the communication signal from the start system load 38. For instance, when the ECU of the start system load 38 transmits a communication signal asking for permission to startup according to the operation of the start system operation switch 39 by the user, the power supply control device 41 determines that the user performed the operation of starting up the start system load 38 when receiving the communication signal.

The process proceeds to step S60 if the power supply control device 41 determines that the user performed the operation of starting up the start system load 38 in step S59.

In step S60, the power supply control device 41 checks the state of the brake switch of the vehicle through the vehicle status checking unit 46, and determines whether or not the brake switch is in the ON state.

The process proceeds to step S61 if the power supply control device 41 determines that the brake switch is in the ON state in step S60, and the power supply control device 41 determines whether or not the shift position of the vehicle is P or N through the vehicle status checking unit 46. The process proceeds to step S63 if the power supply control device 41 determines that the shift position of the vehicle is P or N in step S61.

The process proceeds to step S61 if determined that the user has not performed the operation of starting up the start system load 38 in step S59, if determined that the brake switch is not in the ON state (in the OFF state) in step S60, or if determined that the shift position of the vehicle is not P or N (other than P and N).

In step S61, the power supply control device 41 determines whether or not an elapse time from the time determined that the door of the vehicle changed from close to open in step S51 exceeded ten minutes, and the process returns to step S59 if determined that the elapsed time did not exceed ten minutes.

In other words, the process proceeds to step S63 if the user steps on the brake to turn ON the brake switch, operates the shift lever so that the shift position is at P or N, and turns ON the push switch for engine startup within ten minutes from the time determined that the door of the vehicle changed from close to open in step S11 through the processes of steps S59 to S62.

In step S63, the power supply control device 41 transmits a control signal permitting the startup to the start system load 38. In other words, in this case, the power supply control device 41 permits the startup of the start system load 38 since the conditions that the legitimate user is seated, that the smart key is in the interior of the vehicle, and that the shift position is at P or N, which are conditions for starting up the start system load 38, are satisfied.

After the process of step S63, the process proceeds to step S64, where the ECU of the start system load 38 starts the supply of power to the steering lock control unit (not shown) of the start system load 38, and the process proceeds to step S65.

In step S65, the fail safe power supply control device 42 determines whether or not the steering lock is unlocked by the steering lock control unit of the start system load 38.

As described above, the fail safe power supply control device 42 detects that the control signal for permitting the startup is transmitted from the power supply control device 41 based on the communication signal from the power supply control device 41, and the fail safe power supply control device 42 retransmits the control signal for permitting the startup to the ECU of the start system load 38 if the steering lock of the start system load 38 is not unlocked although the control signal is transmitted. If the steering lock is not unlocked after retransmission (retry) of a predetermined defined number of times has been performed, the fail safe power supply control device 42 determines that the steering lock is not unlocked.

If the fail safe power supply control device 42 determines that the steering lock is not unlocked in step S65, the process proceeds to step S66, and the fail safe power supply control device 42 controls to stop the supply of power to the steering lock control unit of the start system load 38 with respect to the ECU of the start system load 38.

If the fail safe power supply control device 42 determines that the steering lock is unlocked in step S65, the process proceeds to step S67.

In step S67, the ECU of the start system load 38 starts to supply power to the traveling system (not shown) of the start system load 38, and the process proceeds to step S68.

In step S68, the fail safe power supply control device 42 determines whether or not power is supplied to the traveling system of the start system load 38. The fail safe power supply control device 42 performs retry for a defined number of times, similar to the process in step S65.

If the fail safe power supply control device 42 determines that the power is supplied to the traveling system of the start system load 38 in step S68, the process proceeds to step S69, and the ECU of the start system load 38 starts to supply power to the engine startup system (not shown) of the start system load 38. The start system load 38 is thereby actuated, that is, the engine starts up, and the process terminates.

If the fail safe power supply control device 42 determines that the power is not supplied to the traveling system of the start system load 38 in step S68, the process proceeds to step S70.

In step S70, the power supply control device 41 transitions to a state of waiting for the operation of turning OFF the power supply by the user without clearing the authentication state of the user. In other words, in this case, tow-away of the vehicle, and the like may occur due to failure of the traveling system etc., and thus the state transitions to the waiting state without the process of turning OFF the power supply being performed since the supply of power to the traveling system may become necessary.

The process proceeds to step S71 if the power supply control device 41 determines that the elapsed time exceeded ten minutes in step S54, determines that a legitimate user is not seated on the seat in step S57, determined that the smart key is not in the interior of the vehicle in step S58, determines that the elapsed time exceeded ten minutes in step S62, or after the process of step S66.

In step S71, the power supply control device 41 clears the authentication state of the user and transitions each portion of the control unit 40 to the power saving state, whereby the process is terminated. The process is also terminated if the power supply control device 41 determines that the door of the vehicle is not charged from close to open in step S51.

Therefore, in the vehicle power supply system 31, the accessory system load 34 starts up when the condition (e.g., legitimate user is seated) for starting up the accessory system load 34 is satisfied according to the operation of the accessory system operation switch 35. The ignition system load 36 starts up when the conditions (e.g., legitimate user is seated and smart key is in the interior of the vehicle) for starting up the ignition system load 36 are satisfied according to the operation of the ignition system operation switch 37. The start system load 38 starts up when the conditions (e.g., legitimate user is seated, smart key is in the interior of the vehicle, brake switch is ON, and shift position is P or N) for starting up the start system load 38 are satisfied according to the operation of the start system operation switch 39.

The power consumption can be suppressed compared to the prior art since the power is supplied for every load instructed to be started up or actuated.

In other words, since the power is supplied all together to the accessory system load, the ignition system load, and the start system load in the conventional vehicle power supply system, the power is consumed even in loads not instructed to be started up or activated. In the vehicle power supply system 31, on the other hand, the supply of power to the accessory system load 34, the ignition system load 36, and the start system load 38 is carried out according to the instruction to start up or actuate with respect to the respective load, and hence the unnecessary consumption of power is avoided.

Furthermore, the consumption of power can be finely suppressed since the supply of power can be controlled for every accessory system load 34a or 34b, or the ignition system load 36a or 36b. Moreover, the actuation condition may differ for every load, where the consumption of power can be more suppressed by controlling to stop the supply of power while parking with respect to the load that is actuated only while traveling.

In the vehicle power supply system 31, the accessory system load 34 or the ignition system load 36 is actuated when the driver simply operates the accessory system load 34 or the ignition system operation switch 37, and thus the convenience enhances compared to the conventional vehicle power supply system in which the power supply needs to be switched to the ignition position to actuate such loads.

As the fail safe power supply control device 42 can control the ignition system load 36 and the start system load 38 on behalf of the power supply control device 41 even when improper operation occurred by monitoring the power supply control device 41, the ignition system load 36, and the start system load 38, the ignition system load 36 and the start system load 38 can be reliably actuated.

In the present embodiment, the process of confirming the actuation conditions of the power supply control device 41, the ignition system load 36, and the start system load 38 is performed by the power supply control device 42, but the respective ECU of the power supply control device 41, the ignition system load 36, and the start system load 38 may confirm the actuation condition and actuate the respective load.

Each process described with reference to the flowchart described above does not necessarily need to be processed in time-series along the order described in the flowchart, and also includes processes executed in parallel or individually (e.g., parallel process or process by object). The program may be processed by one CPU or may be distributed processed by a plurality of CPUs.

The embodiments of the present invention are not limited to the embodiments described above, and various modifications may be made within the scope not deviating from the gist of the invention.

In accordance with one aspect of the present invention, there is provided a vehicle power supply system including a power supply unit for supplying power to each unit of a vehicle; a plurality of actuation units actuated by the power from the power supply unit; an operation unit arranged for every plurality of actuation units, and operated when actuating the corresponding actuation unit; and a control unit for performing a control of starting supply of power from the power supply unit to the actuation unit for every actuation unit according to the operation on the operation unit when an actuation condition of the actuation unit corresponding to the operation unit is satisfied.

In one aspect of the present invention, a power supply unit for supplying power to each unit of a vehicle; a plurality of actuation units actuated by the power from the power supply unit; and an operation unit arranged for every plurality of actuation units, and operated when actuating the corresponding actuation unit are arranged, where supply of power from the power supply unit to the actuation unit starts according to the operation on the operation unit when an actuation condition of the actuation unit corresponding to the operation unit are satisfied.

According to one aspect of the present invention, the consumption of power can be suppressed, and the convenience can be enhanced.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A vehicle power supply system comprising:
a power supply unit for supplying power to each unit of a vehicle;
a plurality of actuation units actuated by the power from the power supply unit;
an operation unit arranged for each of the plurality of actuation units, and operated when actuating the corresponding actuation unit; and
a control unit for performing a control of starting supply of power from the power supply unit to each of the plurality of actuation units according to the operation of the corresponding operation unit when an actuation condition of the actuation unit corresponding to the operation unit is satisfied.

2. The vehicle power supply system according to claim 1, further comprising:
a replacement control unit for monitoring the control unit and a predetermined one of the plurality of actuation units, and performing the control of starting supply of power from the power supply unit to the predetermined actuation unit, on behalf of the control unit, with respect to the actuation unit that does not actuate although the control to start supply of power that is performed by the control unit.

3. The vehicle power supply system according to claim 1, wherein the actuation condition differs for each of the plurality of actuation units.

4. The vehicle power supply system according to claim 1, further comprising, for each of the plurality of actuation units, an actuation control unit for communicating with the control unit and changing a switch connected to the power supply unit to an ON state when receiving an operation signal from the operation unit.
